(19) United States
(12) Patent Application Publication
(10) Pub. No.: US 2011/0161545 A1
(43) Pub. Date: Jun. 30, 2011

(54) I2C/SPI CONTROL INTERFACE CIRCUITRY, INTEGRATED CIRCUIT STRUCTURE, AND BUS STRUCTURE THEREOF

(75) Inventors: Chi-Tung Chang, Taipei (TW); Hsiu Ming Fan, Taipei (TW); Chuan-Ching Tsai, Taipei (TW)

(73) Assignee: Alcor Micro Corp., Taipei (TW)

(21) Appl. No.: 12/776,473

(22) Filed: May 10, 2010

(30) Foreign Application Priority Data
Dec. 31, 2009 (TW) 098146150

(51) Int. Cl. G06F 13/40

(52) U.S. Cl. 710/305

(57) ABSTRACT

An I²C/SPI control interface circuitry, an integrated circuit structure, and a bus structure thereof are provided. The I²C/SPI control interface circuitry includes an I²C control module and a SPI control module. The I²C control module has an I²C clock port and an I²C data port, and the SPI control module has a SPI clock port, a SPI data input port, a SPI data output port, and a SPI chip enable port. The I²C clock port is electrically connected with the SPI chip enable port to become an I²C clock/SPI chip enable input/output end. The I²C data port is electrically connected with the SPI data input port and the SPI data output port to become an I²C/SPI data input/output end. The SPI clock port is the SPI clock output end. The I²C and SPI control module are alternative to be enabled to avoid signal interference and lower the cost of the package and the manufacture of the integrated circuit.

### BACKGROUND OF THE INVENTION

1. Technical Field

The present invention relates to I²C/SPI control interface circuitries, integrated circuit structures, and bus structures thereof, and more particularly, to an I²C/SPI control interface circuitry, an integrated circuit structure, and a bus structure thereof advantageously configured to prevent signal interference and lower manufacture as well as packaging costs.

2. Description of Related Art

An I²C (inter-integrated circuit) serial communication bus and an SPI (serial peripheral interface) bus are master-slave bus systems in wide use and are configured to control various peripheral devices. However, in practice, the two bus systems have different specifications and thus are incompatible. Hence, it is imperative to render the two bus systems compatible to ensure quality transmission.

FIG. 1A is a schematic view of a conventional I²C/SPI control interface circuitry structure 30. FIG. 1B is a schematic view of a conventional I²C/SPI control interface circuitry structure 30′ having an I²C/SPI selecting unit. FIG. 2A is a schematic view of internal clock timing of the I²C/SPI control interface circuitry structure 30 when an I²C control module 10 is enabled according to the prior art. FIG. 2B is a schematic view of external clock timing of the I²C/SPI control interface circuitry structure 30 when the I²C control module 10 is enabled according to the prior art. FIG. 3A is a schematic view of internal clock timing of the I²C/SPI control interface circuitry structure 30′ when an SPI control module 20 is enabled according to the prior art. FIG. 3B is a schematic view of external clock timing of the I²C/SPI control interface circuitry structure 30′ when the SPI control module 20 is enabled according to the prior art.

Referring to FIG. 1A, both the I²C control module 10 and SPI control module 20 are integrated into the I²C/SPI control interface circuitry structure 30. The I²C control module 10 comprises an I²C clock port 11 and an I²C data port 12. The SPI control module 20 comprises an SPI clock port 21, an SPI data input port 22, an SPI data output port 23, and an SPI chip enable port 24. The I²C clock port 11 and the SPI clock port 21 are electrically connected before being collectively electrically connected to a first transmission line 50. The I²C data port 12, the SPI data input port 22, and the SPI data output port 23 are electrically connected before being collectively electrically connected to a second transmission line 60. The SPI chip enable port 24 is electrically connected to a third transmission line 70.

Referring to FIG. 1B, the I²C/SPI control interface circuitry structure 30′ further comprises an I²C/SPI selecting unit 40 for selectively enabling one of the I²C control module 10 and the SPI control module 20, so as for the enabled I²C control module 10 or the enabled SPI control module 20 to operate.

Referring to FIG. 2A, once the I²C control module 10 is enabled, the I²C clock port 11 will generate an I²C clock signal (I²C_clock) continuously, and the I²C data port 12 will transmit an I²C data signal (I²C_data). With the SPI chip enable port 24 being low-enabled, an SPI chip enable signal (SPI_cs) outputted by the SPI chip enable port 24 always stays at a high logic level whenever the SPI control module 20 is disabled, as does an SPI clock signal (SPI_clock) outputted by the SPI clock port 21 and an SPI data input/output signal (SPI_dido) outputted by the SPI data input port 22 and the SPI data output port 23.

Referring to FIG. 2B, when the I²C control module 10 is enabled, the first transmission line 50 outputs the I²C clock signal (I²C_clock), and the second transmission line 60 outputs the I²C data signal (I²C_data), allowing the third transmission line 70 to stay at a high logic level. Hence, enabling the I²C control module 10 not only precludes the SPI control module 20 from being mistakenly enabled but also prevents the SPI control module 20 from affecting the output of the I²C clock signal (I²C_clock) and the I²C data signal (I²C_data).

Referring to FIG. 3A, once the SPI control module 20 is enabled, the SPI chip enable port 24 will be reduced to a low logic level so as to trigger the SPI control module 20, and the SPI clock port 21 will start to output the SPI clock signal (SPI_clock), allowing the SPI data input port 22 and the SPI data output port 23 to transmit and receive the SPI data input/output signal (SPI_dido). Meanwhile, the I²C clock port 11 and the I²C data port 12 stay at a high logic level.

Referring to FIG. 3B, when the SPI control module 20 is enabled, the first transmission line 50 outputs the SPI clock signal (SPI_clock), and the second transmission line 60 outputs the SPI data input/output signal (SPI_dido), allowing the third transmission line 70 to output the SPI chip enable signal (SPI_cs) and stay at a low logic level.

However, when the SPI control module 20 is enabled (the SPI chip enable signal (SPI_cs) stays at a low logic level) as shown enclosed by a dotted line in FIG. 3B, the first transmission line 50 outputs the SPI clock signal (SPI_clock) continuously, and the second transmission line stays at a high logic level, which is likely to interfere with the I²C control module 10. This causes the I²C control module 10 to erroneously detect that the I²C control module 10 has started to operate. As a result, there is signal interference between the I²C control module 10 and the SPI control module 20 to the detriment of system stability and the quality of data transmission.

### BRIEF SUMMARY OF THE INVENTION

The present invention provides an I²C/SPI control interface circuitry, an integrated circuit structure, and a bus structure thereof to enhance stability and compatibility between an I²C control module and an SPI control module and to ensure quality signal transmission.

The present invention provides an I²C/SPI control interface circuitry, an integrated circuit structure, and a bus structure thereof, which integrate the I²C control module and the SPI control module, so as to reduce the quantity of system output ports and thereby cut costs incurred in fabricating and packaging chips.

The present invention provides an I²C/SPI control interface circuitry, an integrated circuit structure, and a bus structure thereof, which achieve, with a special means of connection, the effective integration of an I²C serial communication bus and an SPI bus and the prevention of interference between signals.

To achieve the above and other objectives, the present invention provides an I²C/SPI control interface circuitry structure, comprising: an I²C control module comprising an I²C clock port and an I²C data port; and an SPI control module comprising an SPI clock port, an SPI data input port, an SPI data output port, and an SPI chip enable port. Therein the I²C clock port and the SPI chip enable port are electrically connected to form an I²C clock/SPI chip enable input/output end. The I²C data port is electrically connected with the SPI data input port and the SPI data output port so as for an I²C/SPI data input/output end to be formed. The SPI clock port forms an SPI clock output end. One of the I²C control module and the SPI control module is selectively enabled to operate.

To achieve the above and other objectives, the present invention further provides an I²C/SPI control interface integrated circuit structure, comprising: an I²C control module comprising an I²C clock port and an I²C data port; and an SPI control module comprising an SPI clock port, an SPI data input port, an SPI data output port, and an SPI chip enable port. The I²C control module and the SPI control module are integrated into the same integrated circuit. The I²C clock port and the SPI chip enable port are electrically connected to form an I²C clock/SPI chip enable input/output end. The I²C data port is electrically connected with the SPI data input port and the SPI data output port so as for an I²C/SPI data input/output end to be formed. The SPI clock port forms an SPI clock output end. One of the I²C control module and the SPI control module is selectively enabled to operate.

To achieve the above and other objectives, the present invention further provides an I²C/SPI bus structure, applicable to an I²C/SPI control interface circuitry/integrated circuit structure and configured for a first transmission state and a second transmission state, comprising: a first transmission line configured for two-way transmission of an I²C clock signal /an SPI chip enable signal; a second transmission line configured for two-way transmission of an I²C data signal /an SPI data input/output signal; and a third transmission line configured for uni-directional transmission of an SPI clock signal from the controlling end to the controlled end. In the first transmission state, the first transmission line and the second transmission line transmit the I²C clock signal and the I²C data signal, respectively. In the second transmission state, the first transmission line, the second transmission line, and the third transmission line transmit the SPI chip enable signal, the SPI data input/output signal, and the SPI clock signal, respectively.

Implementation of the present invention involves at least the following inventive steps:

1. Using an internal port electrical connection structure for effectively preventing interference between the I²C control module and the SPI control module in signal transmission;

2. Integrating the I²C control module and the SPI control module to thereby reduce the quantity of system output ports and cut costs incurred in fabricating and packaging chips; and

3. Using a special means of connection for enhancing stability and compatibility of the I²C/SPI control interface circuitry structure efficiently to thereby ensure quality signal transmission.

The features and advantages of present invention are described in detail hereunder to enable persons skilled in the art to understand and implement the disclosure of the present invention and readily apprehend objectives and advantages of the present invention with references made to the disclosure contained in the specification, the claims, and accompanying drawings.

### BRIEF DESCRIPTION OF THE SEVERAL VIEWS OF THE DRAWINGS

FIG. 1A is a schematic view of a conventional I²C/SPI control interface circuitry structure;

FIG. 1B is a schematic view of a conventional I²C/SPI control interface circuitry structure having an I²C/SPI selecting unit;

FIG. 2A is a schematic view of internal clock timing of the I²C/SPI control interface circuitry structure when an I²C control module is enabled according to the prior art;

FIG. 2B is a schematic view of external clock timing of the I²C/SPI control interface circuitry structure when the I²C control module is enabled according to the prior art;

FIG. 3A is a schematic view of internal clock timing of the I²C/SPI control interface circuitry structure when an SPI control module is enabled according to the prior art;

FIG. 3B is a schematic view of external clock timing of the I²C/SPI control interface circuitry structure when the SPI control module is enabled according to the prior art;

FIG. 4A is a schematic view of an embodiment of an I²C/SPI control interface circuitry structure according to the present invention;

FIG. 4B is a schematic view of an embodiment of another I²C/SPI control interface circuitry structure according to the present invention;

FIG. 5 is a schematic view of an embodiment of an I²C/SPI bus structure and a controlled device according to the present invention;

FIG. 6A is a schematic view of an embodiment of internal clock timing of the I²C/SPI control interface circuitry structure when an I²C control module is enabled according to the present invention;

FIG. 6B is a schematic view of an embodiment of external clock timing of the I²C/SPI control interface circuitry structure when the I²C control module is enabled according to the present invention;

FIG. 7A is a schematic view of an embodiment of internal clock timing of the I²C/SPI control interface circuitry structure when an SPI control module is enabled according to the present invention; and

FIG. 7B is a schematic view of an embodiment of external clock timing of the I²C/SPI control interface circuitry structure when the SPI control module is enabled according to the present invention.

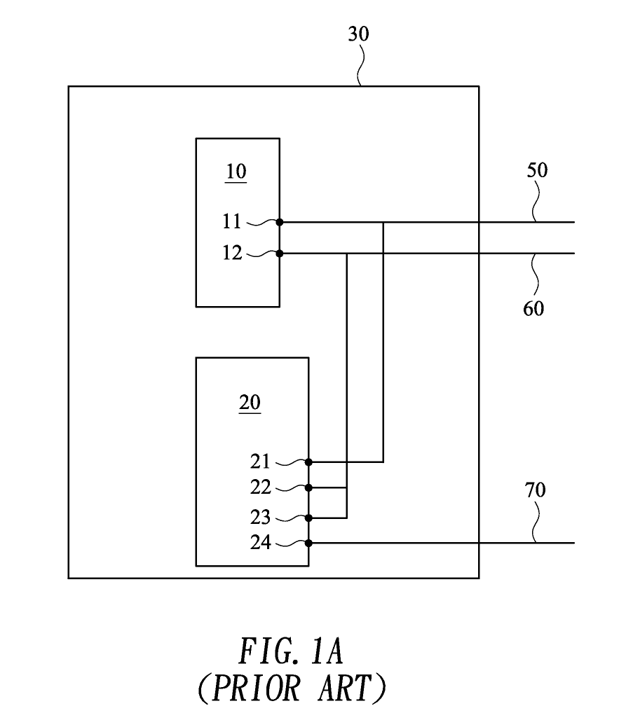

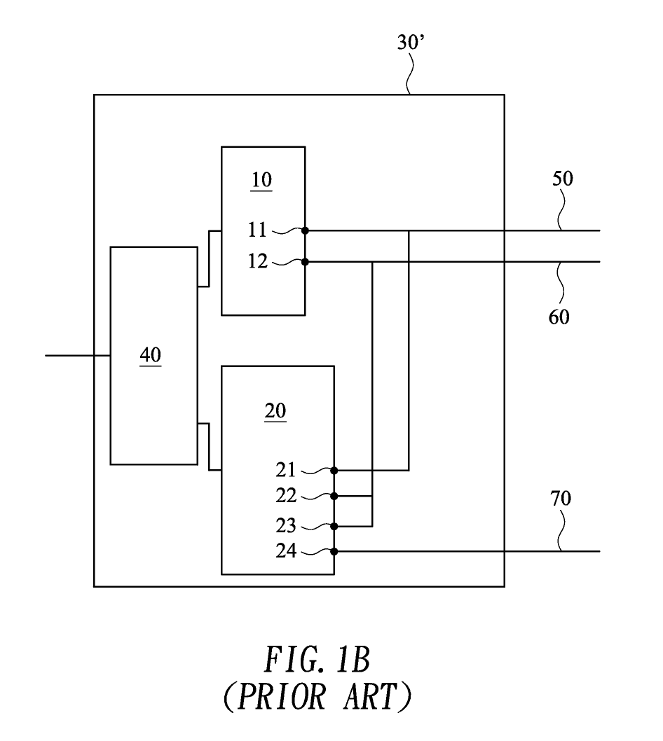

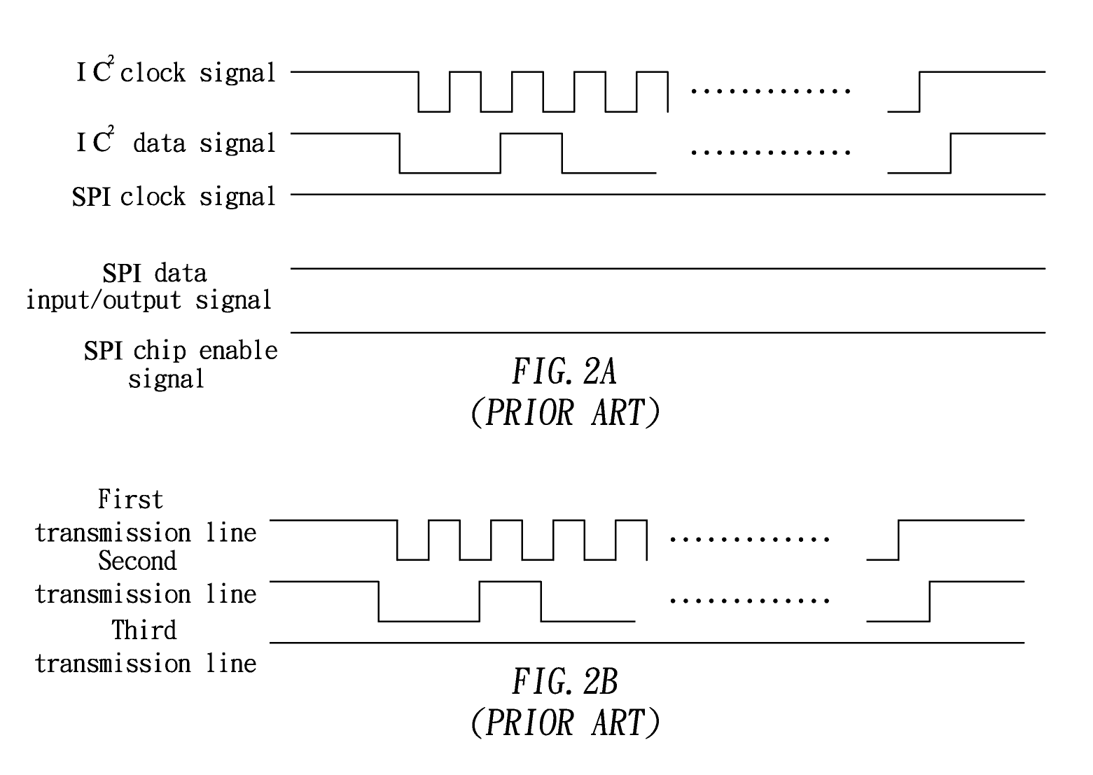

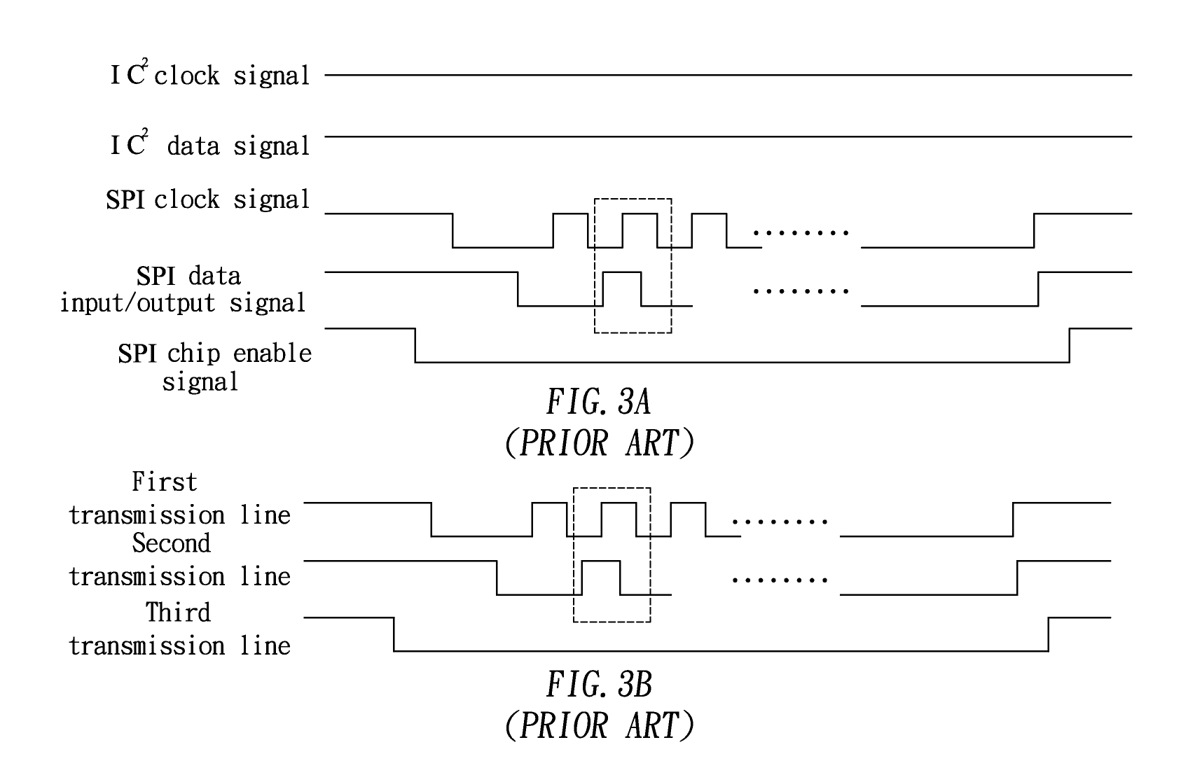

### DETAILED DESCRIPTION OF THE INVENTION

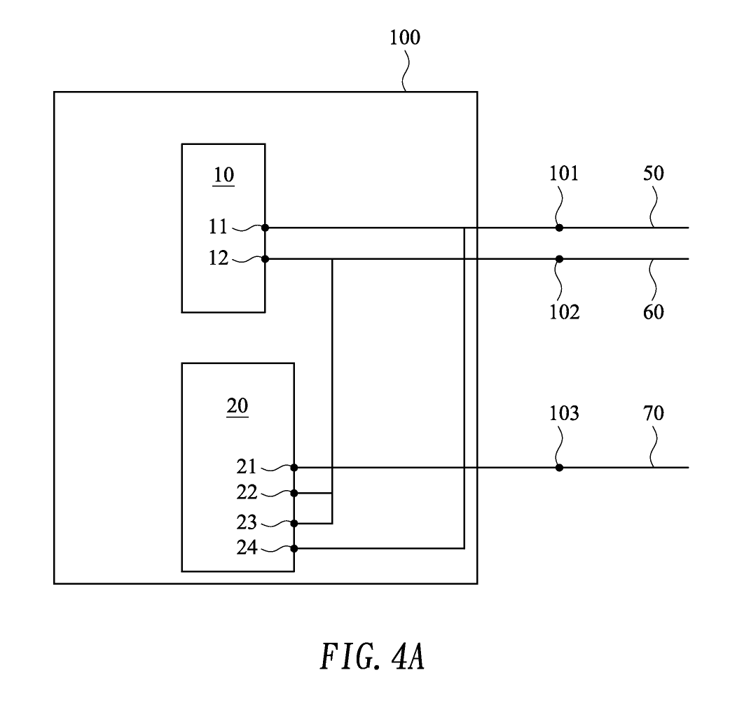

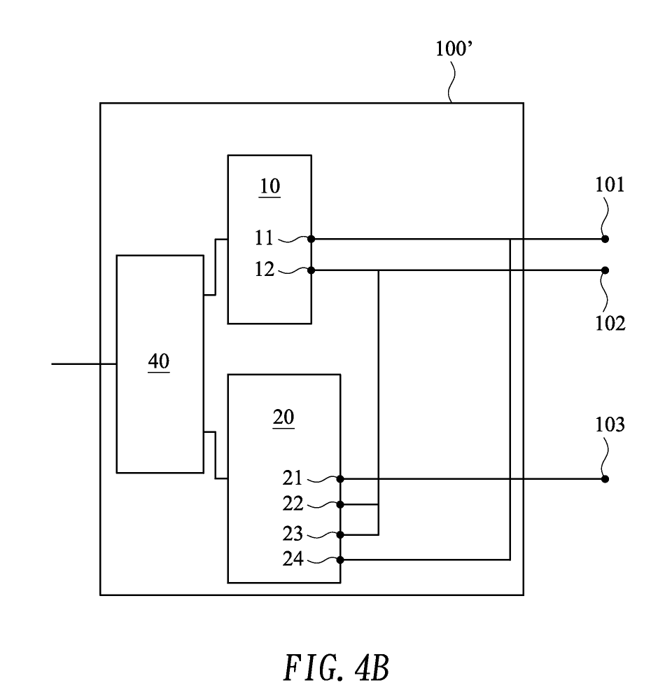

Referring to FIG. 4A, in this embodiment, an I²C/SPI control interface circuitry structure 100 includes an I²C control module 10 and an SPI control module 20.

The I²C control module 10 at least comprises an I²C clock port 11 and an I²C data port 12. The SPI control module 20 at least comprises an SPI clock port 21, an SPI data input port 22, an SPI data output port 23, and an SPI chip enable port 24.

The I²C clock port 11 and the SPI chip enable port 24 are electrically connected to form an I²C clock/SPI chip enable input/output end 101 for connection with a first transmission line 50. The I²C data port 12 is electrically connected with the SPI data input port 22 and the SPI data output port 23 so as to form an I²C/SPI data input/output end 102 for connection with a second transmission line 60. The SPI clock port 21 independently forms an SPI clock output end 103 for connection with a third transmission line 70.

Referring to FIG. 4B, an I²C/SPI control interface circuitry structure 100′ further comprises an I²C/SPI selecting unit 40 for selectively enabling one of the I²C control module 10 and the SPI control module 20 such that one of the I²C control module 10 and the SPI control module 20 is selectively enabled to operate.

In another embodiment of the present invention, the I²C/SPI control interface circuitry structure 100 and 100′ can be further integrated to become an I²C/SPI control interface integrated circuit structure. In other words, the I²C control module 10 and the SPI control module 20 are integrated into the same integrated circuit. The I²C/SPI control interface integrated circuit structure further comprises the I²C/SPI selecting unit 40 for selectively enabling one of the I²C control module 10 and the SPI control module 20 such that the control module required for transmission is selected.

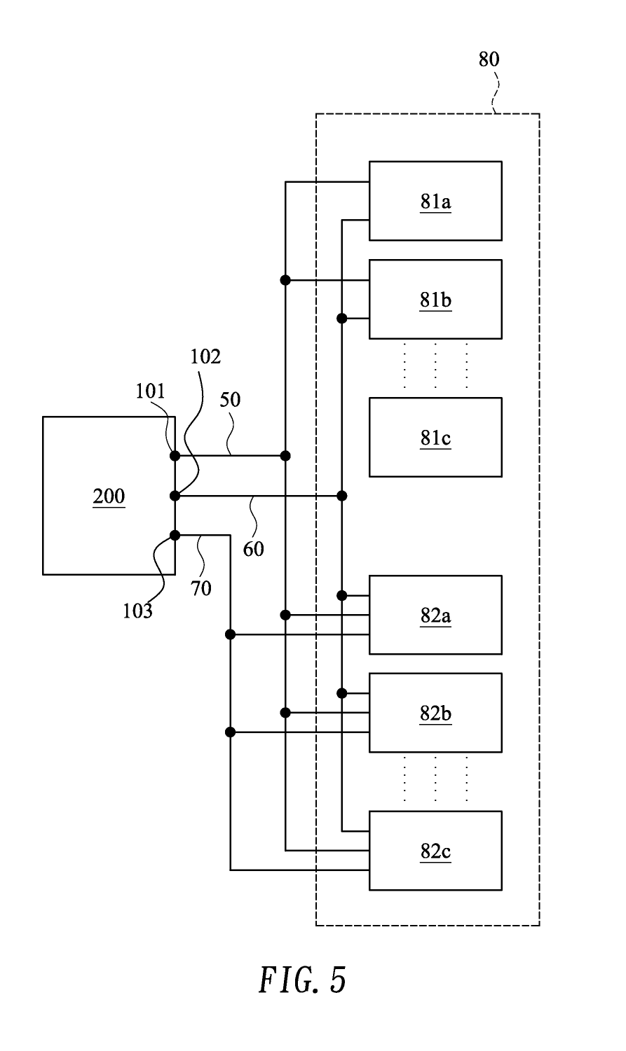

Referring to FIG. 5, in another preferred embodiment of the present invention, an I²C/SPI bus structure 200 applicable to an I²C/SPI control interface circuitry/integrated circuit structure and configured for transmission is provided. The I²C/SPI bus structure 200 is in signal communication with an I²C/SPI controlled device 80 at the controlled end via the first transmission line 50, the second transmission line 60, and the third transmission line 70.

The first transmission line 50 is configured for the two-way transmission of an I²C clock signal (I²C clock) or an SPI chip enable signal (SPI_cs). The second transmission line 60 is configured for two-way transmission of an I²C data signal (I²C data) or an SPI data input/output signal (SPI_dido). The third transmission line 70 is configured for unidirectional transmission of an SPI clock signal (SPI_clock) from the I²C/SPI bus structure 200 at the controlling end to the I²C/SPI controlled device 80 at the controlled end.

For example, after the I²C control module 10 is enabled and regarded as being in the first transmission state, the I²C clock signal (I²C_clock) and the I²C data signal (I²C_data) are transmitted by the first transmission line 50 and the second transmission line 60, respectively. Furthermore, after the SPI control module 20 is enabled and regarded as the second transmission state, the SPI chip enable signal (SPI_cs), the SPI data input/output signal (SPI_dido), and the SPI clock signal (SPI_clock) are transmitted by the first transmission line 50, the second transmission line 60, and the third transmission line 70, respectively.

The I²C/SPI controlled device 80 comprises I²C controlled devices 81a, 81b through 81c, and SPI controlled devices 82a, 82b through 82c. The I²C controlled devices 81a, 81b through 81c are connected to the first transmission line 50 and the second transmission line 60 of the I²C/SPI bus structure 200. The SPI controlled devices 82a, 82b through 82c are connected to the first transmission line 50, the second transmission line 60, and the third transmission line 70 of the I²C/SPI bus structure 200. Although the I²C/SPI bus structure 200 can be concurrently connected to more than one of the I²C controlled devices 81a, 81b through 81c and the SPI controlled devices 82a, 82b through 82c, only one of the I²C control module 10 and the SPI control module 20 of the I²C/SPI bus structure 200 is enabled to serve a corresponding one of the controlled devices at a specific time in the same system.

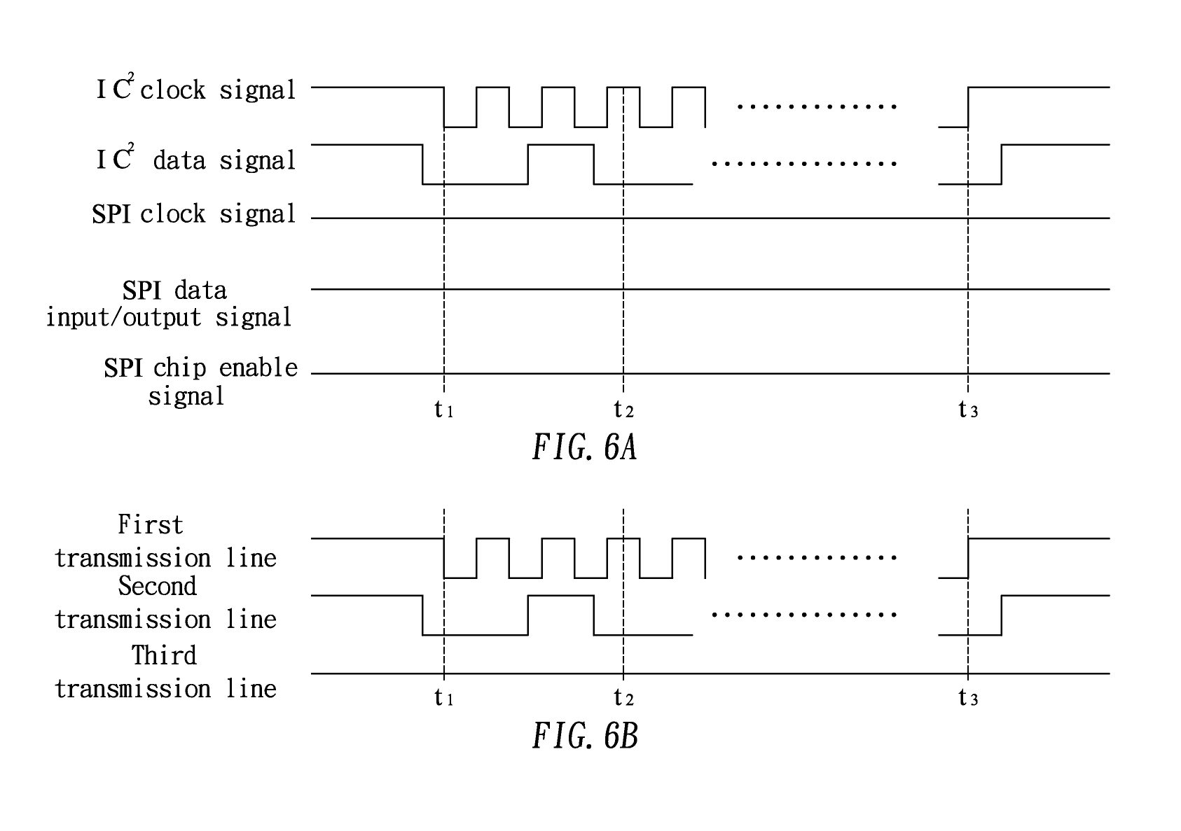

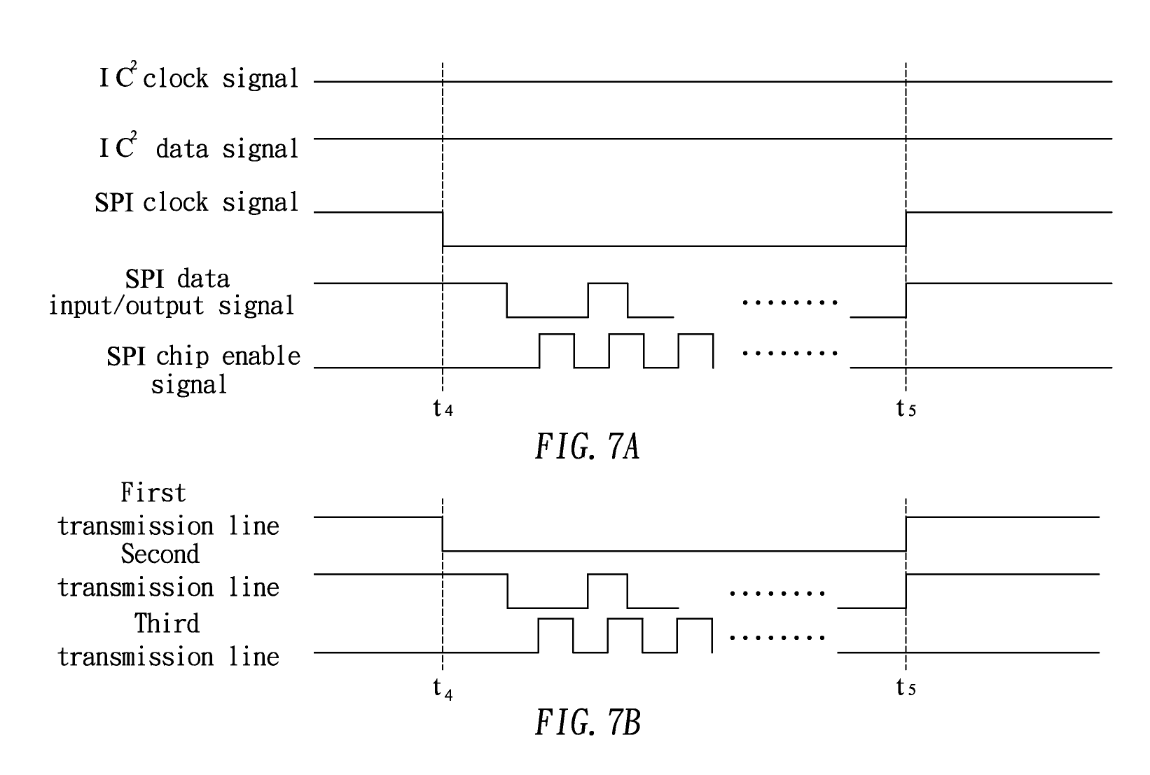

Referring to FIG. 6A through FIG. 7B, for example, the two-way transmission of the I²C clock signal (I²C_clock) or the SPI chip enable signal (SPI_cs) is carried out by the first transmission line 50 and the I²C data signal (I²C_data) or the SPI data input/output signal (SPI_dido) is carried out by the second transmission line 60, whereas unidirectional transmission of the SPI clock signal (SPI_clock) is carried out by the third transmission line 70.

As shown in FIG. 6A and FIG. 6B, after the I²C control module 10 is enabled, the first transmission line 50 starts to output the I²C clock signal (I²C clock) at the point in time t1; meanwhile, the second transmission line 60 starts to transmit the I²C data signal (I²C_data). At the point in time t2, the SPI clock signal (SPI_clock) is not actuated, and thus the SPI control module 20 is not subjected to interference. At the point in time t3, the I²C clock signal (I²C_clock) is stopped, which stops the transmission of the I²C data signal (I²C_data). Meanwhile, in the course of signal transmission, the SPI clock signal (SPI_clock) outputted by the SPI clock port 21 stays at a low logic level, but the SPI data input/output signal (SPI_dido) outputted by the SPI data output port 23 and the SPI data input port 22 stays at a high logic level.

As shown in FIG. 6B, after the I²C control module 10 is enabled, the first transmission line 50 and the second transmission line 60 transmit the I²C clock signal (I²C_clock) and the I²C data signal (I²C_data) to the I²C controlled devices 81a, 81b through 81c, respectively. Because none of the I²C controlled devices 81a, 81b through 81c is connected to the third transmission line 70, the I²C controlled devices 81a, 81b through 81c are not be affected by any signal transmitted by the third transmission line 70. In the course of signal transmission, the SPI chip enable signal (SPI_cs) outputted by the SPI chip enable port 24 always stays at a high logic level, and thus neither the SPI control module 20 nor the SPI controlled devices 82a, 82b through 82c are enabled and affected. Furthermore, signal interference does not occur.

As shown in FIG. 7A and FIG. 7B, for example, the enabling of the SPI control module 20 is followed by transmission of the SPI chip enable signal (SPI_cs) by the first transmission line 50, transmission and reception of the SPI data input/output signal (SPI_dido) by the second transmission line 60, and transmission of the SPI clock signal (SPI_clock) to the SPI controlled devices 82a, 82b through 82c by the third transmission line 70.

At the point in time t4, the SPI chip enable port 24 starts to output the SPI chip enable signal (SPI_cs) via the first transmission line 50, and the SPI controlled devices 82a, 82b, . . . , 82c are low-enabled. The I²C controlled devices 81a, 81b through 81c are enabled on the premise of fulfilling the initial conditions, namely a high logic level of the I²C clock signal (I²C_clock) and the switching of the I²C data signal (I²C_data) from a high logic level to a low logic level. However, the SPI chip enable signal (SPI_cs) outputted by the first transmission line 50 is of a low logic level when the SPI control module 20 is enabled. Hence, the starting conditions for the I²C controlled devices 81a, 81b through 81c are not met, nor are the I²C controlled devices 81a, 81b through 81c enabled to thereby cause signal interference.

Afterward, the SPI data input port 22 and the SPI data output port 23 start to transmit and receive the SPI data input/output signal (SPI_dido), and the SPI clock port 21 starts to transmit the SPI clock signal (SPI clock). Hence, the SPI control module 20 transmits and receives the SPI data input/output signal (SPI_dido) via the second transmission line 60, and the third transmission line 70 starts to transmit the SPI clock signal (SPI_clock).

At the point in time t5, the SPI control module 20 is no longer enabled, the conditions for enabling the I²C controlled devices 81a, 81b through 81c have hitherto not been met, and in consequence, the SPI control module 20 can be actuated without interfering with the I²C controlled devices 81a, 81b through 81c.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and variations made to the foregoing embodiments without departing from the spirit and principles in the disclosure of the present invention should fall within the scope of the invention as set forth in the appended claims.

What is claimed is:

1. An I²C/SPI control interface circuitry structure, comprising:
an I²C control module comprising an I²C clock port and an I²C data port; and
an SPI control module comprising an SPI clock port, an SPI data input port, an SPI data output port, and an SPI chip enable port;
the I²C clock port and the SPI chip enable port being electrically connected to form an I²C clock/SPI chip enable input/output end, the I²C data port being electrically connected with the SPI data input port and the SPI data output port so as for an I²C/SPI data input/output end to be formed, the SPI clock port forming an SPI clock output end, and one of the I²C control module and the SPI control module being selectively enabled to operate.

2. The I²C/SPI control interface circuitry structure of claim 1, further comprising an I²C/SPI selecting unit for selectively enabling one of the I²C control module and the SPI control module.

3. An I²C/SPI control interface integrated circuit structure, comprising:
an I²C control module comprising an I²C clock port and an I²C data port; and
an SPI control module comprising an SPI clock port, an SPI data input port, an SPI data output port, and an SPI chip enable port;
the I²C control module and the SPI control module being integrated into a same integrated circuit, the I²C clock port and the SPI chip enable port being electrically connected to form an I²C clock/SPI chip enable input/output end, the I²C data port being electrically connected with the SPI data input port and the SPI data output port so as for an I²C/SPI data input/output end to be formed, the SPI clock port forming an SPI clock output end, and one of the I²C control module and the SPI control module being selectively enabled to operate.

4. The I²C/SPI control interface integrated circuit structure of claim 3, further comprising an I²C/SPI selecting unit for selectively enabling one of the I²C control module and the SPI control module.

5. An I²C/SPI bus structure, applicable to an I²C/SPI control interface circuitry/integrated circuit structure and configured for a first transmission state and a second transmission state, comprising:
a first transmission line configured for two-way transmission of an I²C clock signal /an SPI chip enable signal;
a second transmission line configured for two-way transmission of an I²C data signal /an SPI data input/output signal; and
a third transmission line configured for unidirectional transmission of an SPI clock signal from the controlling end to the controlled end;
in the first transmission state, the first transmission line and the second transmission line transmitting the I²C clock signal and the I²C data signal, respectively, and in the second transmission state, the first transmission line, the second transmission line, and the third transmission line transmitting the SPI chip enable signal, the SPI data input/output signal, and the SPI clock signal, respectively.
